(19) United States
(12) Patent Application Publication
(10) Pub. No.: US 2023/0033260 A1
(43) Pub. Date: Feb. 2, 2023

(54) USER EQUIPMENT AND METHOD OF SRS TRANSMISSION

(71) Applicants: NTT DOCOMO, INC., Tokyo (JP); DOCOMO INNOVATIONS INC., Palo Alto, CA (US)

(72) Inventors: Nadisanka Rupasinghe, Tokyo (JP); Yuki Matsumura, Tokyo (JP); Satoshi Nagata, Tokyo (JP)

(73) Assignee: NTT DOCOMO, INC., Tokyo (JP)

(21) Appl. No.: 17/758,564

(22) PCT Filed: Apr. 16, 2021
(86) PCT No.: PCT/US2021/027687

§ 371 Date: Jul. 8, 2022

Related U.S. Application Data
(60) Provisional application No. 63/062,972, filed on Aug. 7, 2020.
(60) Provisional application No. 63/154,066, filed on Feb. 26, 2021.
(60) Provisional application No. 63/011,934, filed on Apr. 17, 2020.

(51) Int. Cl. H04L 5/00; H04B 7/0413; H04W 72/04

(52) U.S. Cl. CPC H04L 5/0051; H04B 7/0413; H04W 72/048

(57) ABSTRACT

A terminal incudes a processor, a transmitter, and Rx antenna ports. The number of the Rx antenna ports is less than or equal to 8. The transmitter transmits a sounding reference signal (SRS) using the Rx antenna ports. The processor that switches the antenna ports for the SRS transmission. The number of Rx antenna ports is 8. A method of communicating with a terminal including 8 Rx antenna ports includes transmitting, to a base station, an SRS; and switching among the 8 Rx antenna ports for the SRS transmission.

### BACKGROUND

### Technical Field

One or more embodiments disclosed herein relate to a method of sounding reference signal (SRS)-assisted downlink (DL) channel state information (CSI) acquisition for up to 8 antenna ports.

### Description of Related Art

The current new radio (NR) standard supports SRS switching only up to 4 Rx antenna ports.

On the other hand, the NR standard does not define how to identify the requirement of supporting SRS switching for up to 8 Rx antenna ports in NR multiple-input and multiple-output (MIMO) technologies for Rel. 17.

MIMO work item description (WID) for Rel. 17 indicates the following items, which are not determined:

Enhancement on SRS, targeting both frequency range (FR)1 and FR2:

a. Identify and specify enhancements on aperiodic SRS triggering to facilitate more flexible triggering and/or downlink control information (DCI) overhead/usage reduction

b. Specify SRS switching for up to 8 antennas (e.g., xTyR, x={1, 2, 4} and y={6,8})

c. Evaluate and, if needed, specify the following mechanism(s) to enhance SRS capacity and/or coverage: SRS time bundling, increased SRS repetition, partial sounding across frequency

### CITATION LIST

### Non-Patent Reference

[Non-Patent Reference 1] 3GPP RP 193133, “New WID: Further enhancements on MIMO for NR”, December, 2019

[Non-Patent Reference 2] 3GPP TS 38.214, “NR; Physical procedure for data (Release 16)”

[Non-Patent Reference 3] 3GPP TS 38.331, “NR; Radio Resource Control; Protocol specification (Release 15)”

[Non-Patent Reference 4] 3GPP TS 38.211, “NR; Physical channels and modulation (Release 15)”

### SUMMARY

One or more embodiments provide a method of SRS switching extended to support up to 8 antenna ports.

According to one or more embodiments, a user equipment (UE) includes up to 8 Rx antenna ports; a transmitter that transmits a sounding reference signal (SRS) to a base station; and a processor that switches available Tx antenna ports to acquire DL CSI for 8 Rx antenna ports, with the SRS transmission .

According to one or more embodiments, a method of communicating with a terminal including up to 8 Rx antenna ports includes transmitting a sounding reference signal (SRS) to a base station; and switching among the 8 Rx antenna ports with the SRS transmission from Tx antenna ports (Note that # of Tx antenna ports are less than or equal to # of Rx antenna ports).

Other embodiments and advantages of the present invention will be recognized from the description and figures.

### BRIEF DESCRIPTION OF THE DRAWINGS

FIG. 1 shows an example of a wireless communication system according to one or more embodiments.

FIG. 2 shows an example of a UE transceiver architecture 2T4R.

FIG. 3 shows an example of 1T2R.

FIG. 4 shows an example of 2T4R.

FIG. 5 shows an example of 1T4R.

FIG. 6 shows another example of 1T4R

FIG. 7A shows an example where the UE transceiver architecture is 1T1R.

FIG. 7B shows an example where the UE transceiver architecture is 2T2R.

FIG. 7C shows an example where the UE transceiver architecture is 4T4R.

FIG. 8 shows a table showing minimum guard periods between SRS resources.

FIG. 9 shows an example of DL CSI acquisition according to one or more embodiments.

FIG. 10 shows an example of DL CSI acquisition according to one or more embodiments.

FIG. 11 shows an example of DL CSI acquisition according to one or more embodiments.

FIG. 12 shows an example of DL CSI acquisition according to one or more embodiments.

FIG. 13 shows an equation to determine slots transmitting a particular SRS resource according to one or more embodiments.

FIG. 14 shows an example of DL CSI acquisition according to one or more embodiments.

FIG. 15 shows an example of DL CSI acquisition according to one or more embodiments.

FIG. 16 shows an example of DL CSI acquisition according to one or more embodiments.

FIG. 17 shows an example of DL CSI acquisition according to one or more embodiments.

FIG. 18 shows an example of DL CSI acquisition according to one or more embodiments.

FIG. 19 shows an example of DL CSI acquisition according to one or more embodiments.

FIG. 20 shows an example of DL CSI acquisition according to one or more embodiments.

FIG. 21 shows an example of DL CSI acquisition according to one or more embodiments.

FIG. 22 shows an example of DL CSI acquisition according to one or more embodiments.

FIG. 23 shows an example of DL CSI acquisition according to one or more embodiments.

FIG. 24 shows an example of DL CSI acquisition according to one or more embodiments.

FIG. 25 shows an example of DL CSI acquisition according to one or more embodiments.

FIG. 26 shows an example of DL CSI acquisition according to one or more embodiments.

FIG. 27 shows an example of DL CSI acquisition according to one or more embodiments.

FIG. 28 shows an example of a configuration of a BS according to one or more embodiments.

FIG. 29 shows an example of a configuration of a UE according to one or more embodiments.

### DETAILED DESCRIPTION

Embodiments of the present invention will be described in detail below with reference to the drawings. Like elements in the various figures are denoted by like reference numerals for consistency.

In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

Wireless Communication System

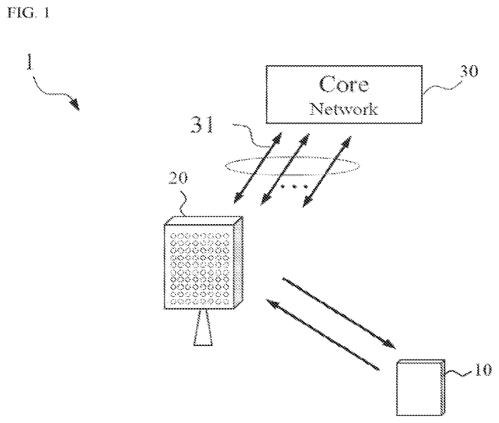

FIG. 1 is a wireless communications system 1 according to one or more embodiments of the present invention. The wireless communication system 1 includes a user equipment (UE) 10, a base station (BS) 20, and a core network 30. The wireless communication system 1 may be a NR system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB). The BS 20 may be referred to as a network (NW) 20. For example, the BS 20 may transmit DL signals such as a CSI-RS and DCI.

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10. For example, the UE 10 may transmit UL signals such as an SRS and CSI report. The UE may be referred to as a mobile station, a mobile terminal, or a terminal.

The UE 10 includes a central processing unit (CPU) such as a processor, a random access memory (RAM), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

UE Sounding Procedure for DL CSI Acquisition

In one or more embodiments, one or a plurality of SRS resources may be configured to the UE 10. An SRS resource set related to a given number of SRS resources may be configured to the UE 10. The number of SRS resources or SRS resource sets configured to the UE 10 may be limited by a maximum transmission rank (the number of layers). Each SRS resource may be associated with one or more SRS ports.

The UE 10 may be configured with one or more SRS resource sets as configured by the higher layer parameter SRS-ResourceSet or SRS-PosResourceSet. For sounding a downlink (DL) channel, one or more SRS resource sets with usage may be set to parameter ‘antenna switching.’ The number of ports of an SRS resource in an SRS resource set with usage set to ‘antenna switching’ depends on available transmitter (Tx) ports at the UE 10.

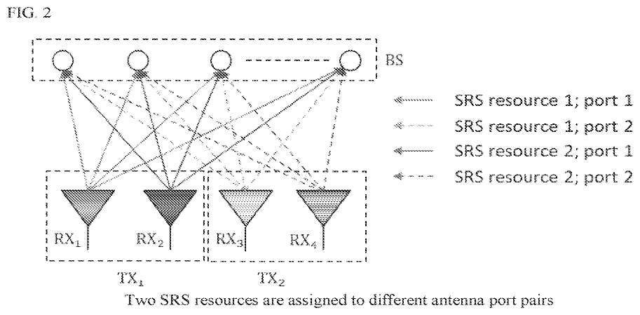

FIG. 2 shows an example of the UE transceiver architecture of the UE 10 with 2T4R (2 Tx ports, 4 receiver (Rx) ports). For DL CSI acquisition, the UE is configured with 2 SRS resources each with 2-ports, which is equal to number of Tx ports. According to Section 6.2.1.2 of 3GPP TS 38.214, for 2T4R, up to two SRS resource sets configured with a different value for the higher layer parameter resourceType in SRS-ResourceSet set, where each SRS resource set has two SRS resources transmitted in different symbols, each SRS resource in a given set consisting of two SRS ports, and the SRS port pair of the second resource is associated with a different UR antenna port pair than the SRS port pair of the first resource.

In the UE transceiver architectures that applies antenna switching for channel sounding (for up to 4 antennas), the number of the UE antennas of the UE 10 may be 1T2R, 2T4R, 1T4R, 1T4R/2T4R, or T=R.

A UE capability of handling different transceiver architectures are reported using supportedSRS-TxPortSwitch parameter. Feasible capability combinations are as follows:

‘t1r2’ for 1T2R

‘t1r1-t1r2’ for 1T=1R/1T2R

‘t2r4’ for 2T4R

‘t1r4’ for 1T4R

‘t1r1-t1r2-t1r4’ for 1T=1R/1T2R/1T4R

‘t1r4-t2r4’ for 1T4R/2T4R

‘t1r1-t1r2-t2r2-t2r4’ for 1T=1R/1T2R/2T=2R/2T4R

‘t1r1-t1r2-t2r2-t1r4-t2r4’ for 1T=1R/1T2R/2T=2R/1T4R/2T4R

‘t1r1’ for 1T=1R

‘t2r2’ for 2T=2R

‘t1r1-t2r2’ for 1T=1R/2T=2R

‘t4r4’ for 4T=4R

‘t1r1-t2r2-t4r4’ for 1T=1R/2T=2R/4T=4R

Next, how different SRS resource allocation configurations assist in acquiring DL CSI for different transceiver architectures will be described below.

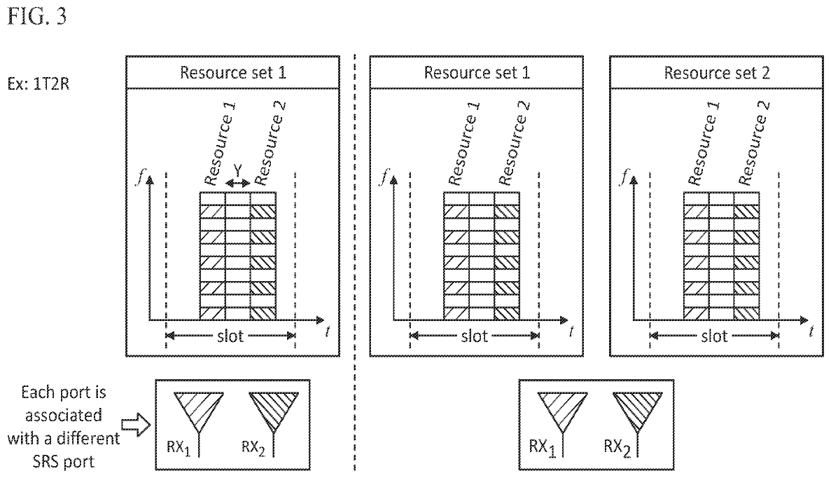

In FIGS. 3-7, 9-12, and 14-19, Resource set x (e.g., x=1, 2, . . . ) indicates an SRS resource set and is referred to as SRS Resource set x. Resource y (e.g., y=1, 2, . . . ) indicates an SRS resource and is referred to as SRS Resource y. RXi (e.g., i=1, 2, . . . ) indicates an RX antenna port of the UE 10. The SRS resource set includes one or multiple SRS resources. Each SRS resource can support 1, 2 or 4 ports. For DL CSI acquisition with SRS, UE antenna ports have to be uniquely associated with SRS ports.

SRS Configuration for DL CSI Acquisition with 1T2R

FIG. 3 shows Case 1 of the UE transceiver architecture of the UE 10 with 1T2R according to one or more embodiments. For 1T2R, up to two SRS resource sets configured with a different value for the higher layer parameter resource Type in SRS-ResourceSet set, where each set has two SRS resources transmitted in different symbols, each SRS resource in a given set consisting of a single SRS port, and the SRS port of the second resource in the set is associated with a different UE antenna port than the SRS port of the first resource in the same set.

In Case 1, one resource set is sufficient and possible to sound within 1 slot. With two SRS resource sets, it is possible to sound with repetition. Accordingly, two SRS resource sets can be of different resourceType.

SRS Configuration for DL CSI Acquisition with 2T4R

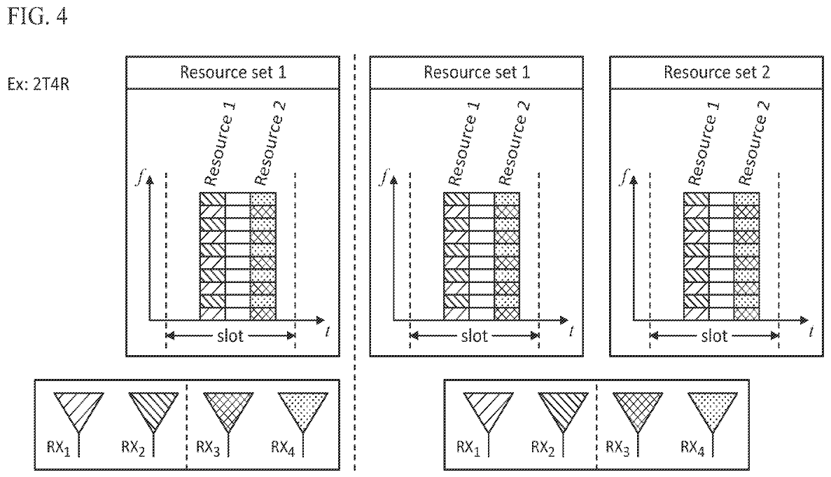

FIG. 4 shows Case 2 of the UE transceiver architecture of the UE 10 with 2T4R according to one or more embodiments. For 2T4R, up to two SRS resource sets configured with a different value for the higher layer parameter resourceType in SRS-ResourceSet set, where each SRS resource set has two SRS resources transmitted in different symbols, each SRS resource in a given set consisting of two SRS ports, and the SRS port pair of the second resource is associated with a different UE antenna port pair than the SRS port pair of the first resource.

In Case 2, one SRS resource set may be sufficient and possible to sound within 1 slot. With two SRS resource sets, it is possible to sound with repetition.

SRS Configuration for DL CSI Acquisition with 1T4R

In Case 3 UE transceiver architecture, 1T4R is discussed.

In Case 3.1, for 1T4R, zero or one SRS resource set configured with higher layer parameter resourceType in SRS-ResourceSet set to ‘periodic’ or ‘semi-persistent’ with four SRS resources transmitted in different symbols, each SRS resource in a given set consisting of a single SRS port, and the SRS port of each SRS resource is associated with a different UE antenna port.

In Case 3.2, for 1T 4R, zero or two SRS resource sets each configured with higher layer parameter resourceType in SRS-ResourceSet set to ‘aperiodic’ and with a total of four SRS resources transmitted in different symbols of two different slots, and where the SRS port of each SRS resource in the given two sets is associated with a different UE antenna port. The two sets are each configured with two SRS resources, or one set is configured with one SRS resource and the other set is configured with three SRS resources. The UE shall expect that the two sets are both configured with the same values of the higher layer parameters alpha, p0, pathlossReferenceRS, and srs-PowerControlAdjustmentStates in SRS-ResourceSet. The UE shall expect that the value of the higher layer parameter aperiodicSRS-ResourceTrigger or the value of an entry in AperiodicSRS-ResourceTriggerlist in each SRS-ResourceSet is the same, and the value of the higher layer parameter slot/Offset in each SRS-ResourceSet is different.

### EXAMPLE 1

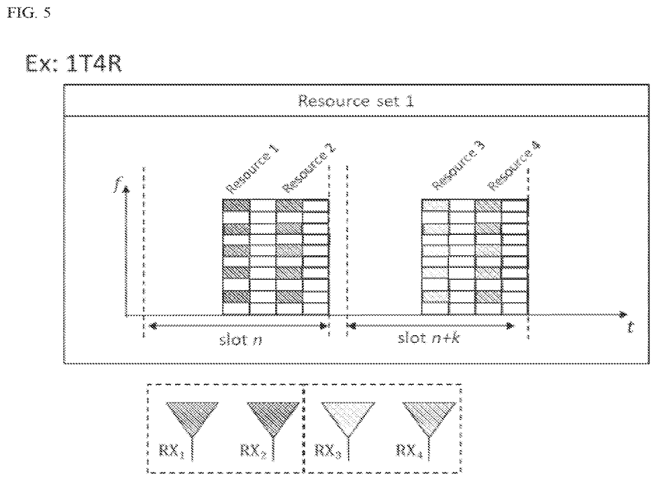

FIG. 5 shows Example 1 that applies Case 3.1 where the number of the UE antennas is 1T4R and ‘periodic’ or ‘semi-persistent’ is set to resourceType. In this example, it is not possible to have all 4 SRS resources in the same slot due to following restrictions:

Different SRS resources need to be transmitted in different symbols; and

A guard period of Y symbols is necessary in-between SRS resources of the same set.

Thus, even though one SRS resource set is sufficient, it is not possible to sound within 1 slot. Accordingly, SRS resources in the set can be in 2, 3 or 4 different slots.

### EXAMPLE 2

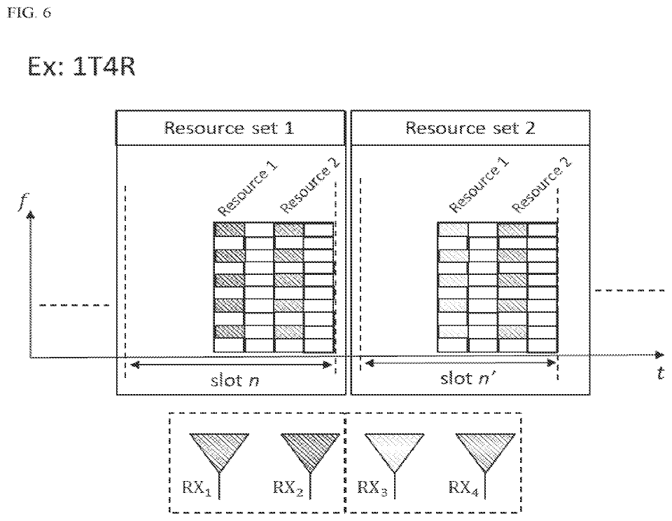

FIG. 6 shows Example 2 that applies Case 3.2 where the UE transceiver architecture is 1T4R and ‘aperiodic’ is set to resourceType. In this example, 2 SRS resource sets are required and sounding is done using 2 slots.

Possible SRS resource allocations across SRS resource sets may be:

Set 1:2; Set 2:2

Set 1:1; Set 2:3

The two sets are configured with the same value for following higher-layer parameters: alpha; p0; pathlossReferenceRS; srs-PowerControlAdjustmentStates; and aperiodicSRS-ResourceTrigger.

According to “aperiodicSRS-ResourceTrigger,” both sets are triggered at the same time.

The value of the higher layer parameter slotOffset in each SRS-ResourceSet may be different. Two sets may be transmitted in different slots. Further, it is possible that the same list of t values are higher layer configured in each SRS-ResourceSet. Then, the same t value is indicated by triggering DCI for both sets.

In addition, it is also possible that the higher layer parameter slot/Offset in each SRS-ResourceSet is the same. Under such situation, it is possible that different lists of t values are higher layer configured in each SRS-ResourceSet. Then, the indicated t value by triggering DCI can be different for different sets.

SRS Configuration for DL CSI Acquisition with 1T=1R, 2T=2R, or 4T=4R

In Case 4 of the UE transceiver architectures, 1T=1R, 2T=2R, or 4T=4R are discussed. For 1T =1R, 2T=2R, or 4T=4R, up to two SRS resource sets each with one SRS resource, where the number of SRS ports for each SRS resource is equal to 1, 2, or 4.

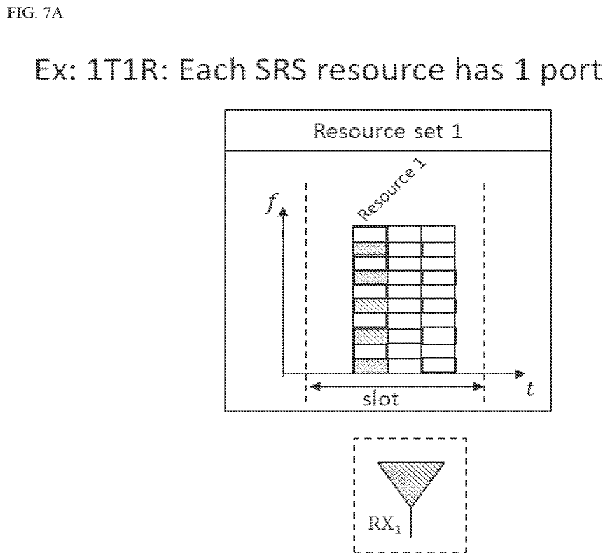

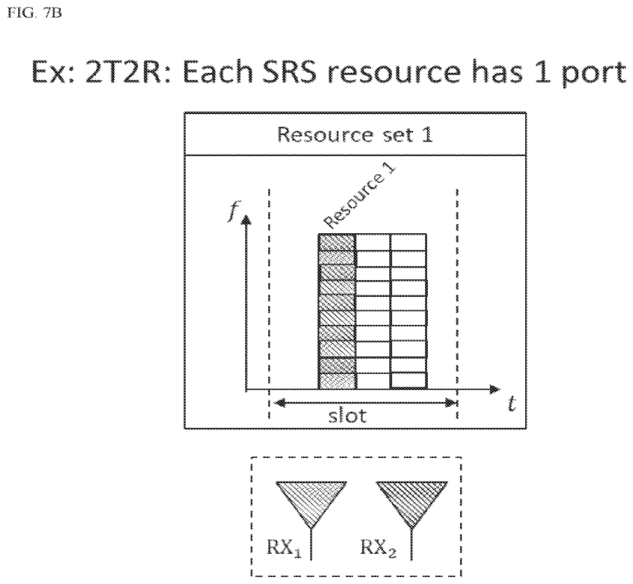

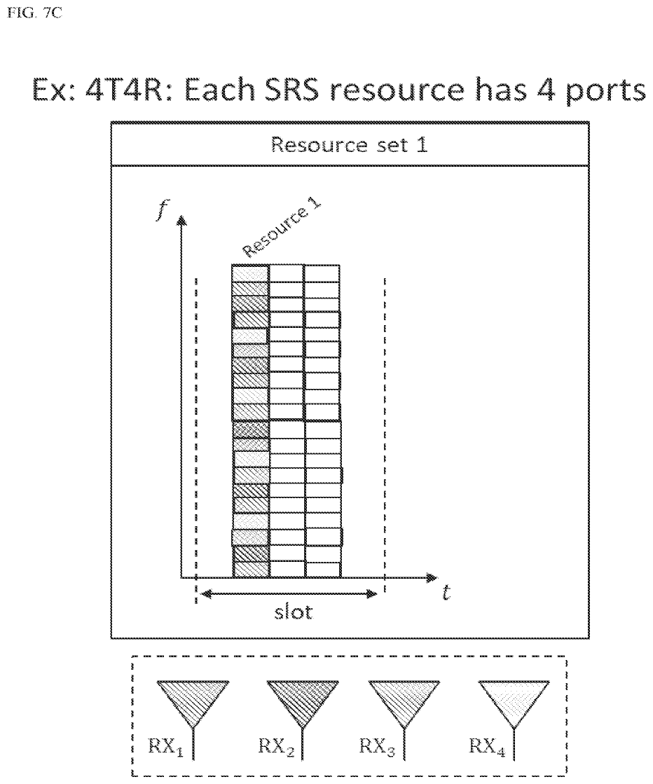

FIG. 7A shows an example of the UE transceiver architecture, 1T1R. In FIG. 7A, each SRS resource has 1 port.

FIG. 7B shows an example of the UE transceiver architecture, 2T2R. In FIG. 7B, each SRS resource has 1 port and the second resource set can be used for repetition.

FIG. 7C shows an example of the UE transceiver architecture, 4T4R. In FIG. 7C, each SRS resource has 4 ports.

Other Important Configuration Requirements

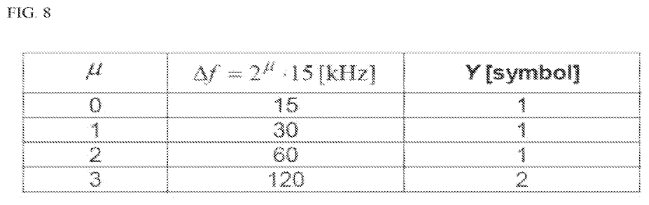

The UE 10 is configured with a guard period of Y symbols, in which the UE 10 does not transmit any other signal, in the case the SRS resources of a set are transmitted in the same slot. The guard period is in-between the SRS resources of the set. FIG. 8 shows a table showing minimum guard periods between two SRS resources of an SRS resource set for antenna switching.

The UE 10 shall expect to be configured with the same or different number of SRS ports for all SRS resources in the SRS resource set(s) with higher layer parameter usage set as ‘antennaSwitching.’

If the indicated UE capability is ‘1T2R’, ‘2T4R,’ or ‘1T4R,’ the UE 10 shall not expect to be configured or triggered with more than one SRS resource set in the same slot.

If the indicated UE capability is ‘1T=1R’, ‘2T=2R’, or ‘4T=4R’, the UE 10 shall not expect to be configured or triggered with more than one SRS resource set in the same symbol.

Next, how supporting of SRS switching up to 8 antennas can be handled will be described below.

Supporting Antenna Switching Up to 8 Antennas (Rel. 17)

In one or more embodiments, SRS switching for up to 8 antennas (e.g., xTyR, x={1, 2, 4} and y={6, 8}) may be specified. Therefore, as the UE transceiver architectures, 1T6R, 1T8R, 2T6R, 2T8R, 4T6R, and 4T8R may be supported.

According to one or more embodiments, the number of Rx antenna ports of the UE may be less than or equal to 8.

First Embodiment

According to First Embodiment, at least one of the following new UE capability indications may be supported by parameter, supportedSRS-TxPortSwitch to capture new transceiver architectures:

‘t1r6’ for 1T6R

‘t2r6’ for 2T6R

‘t1r1-t1r2-t1r4-t1r6’ for 1T=1R/1T2R/1T4R/1T6R

‘t1r2-t2r2-t1r4-t2r4-t1r6-t2r6’ for 1T=1R/1T2R/2T=2R/1T4R/2T4R/1T6R/2T6R

‘t1r6-t2r6’ for 1T6R/2T6R

‘t1r8’ for 1T8R

‘t2r8’ for 2T8R

‘t1r1-t1r2-t1r4-t1r6-t1r8’ for 1T=1R/1T2R/1T4R/1T6R/1T8R

‘t1r2-t2r2-t1r4-t2r4-t1r6-t2r6-t1r8-t2r8’ for 1T=1R/1T2R/2T=2R/1T4R/2T4R/1T6R/2T6R/1T8R/2T8R

‘t1r8-t2r8’ for 1T8R/2T8R

‘t4r6’ for 4T6R

‘t4r8’ for 4T8R

‘t1r2-t2r2-t1r4-t2r4-t1r6-t2r6-t4r6-t1r8-t2r8-t4r8’ for 1T=1R/1T2R/2T=2R/1T4R/2T4R/1T6R/2T6R/4T6R/1T8R/2T8R/4T8R

In First Embodiment, a UE capability indication parameter includes supportedSRS-TxPortSwitch that is associated with usage antennaswitching.' The antennaswitching' is updated to capture new transceiver architectures.

Second Embodiment: DL CSI Acquisition—2T6R Architecture

In Option (Opt)1 of the Second Embodiment, for 2T6R, up to n SRS resource sets each configured with a different value for the higher layer parameter resourceType where each set has 3 SRS resources transmitted in different symbols. Each SRS resource in a given set consisting of two SRS ports, and the SRS port pair of one resource is associated with a different UE antenna port pair than the SRS port pair of other resources.

In Opt1.1, n may be specified in the specification (e.g., 3GPP Technical Specification). For example, n may be 1, 2, or 3.

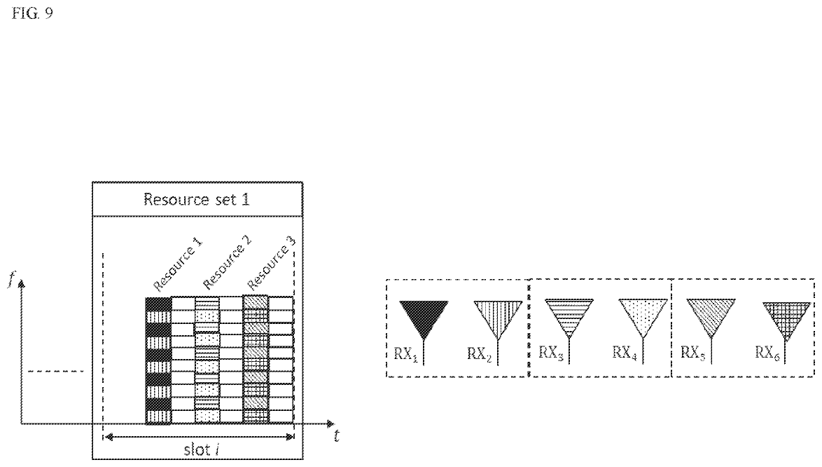

As shown in FIG. 9, for n=1, a single SRS resource set (Resource set 1) having 3 SRS resources (Resources 1, 2, and 3) may be selected. Each SRS port in a given SRS resource is associated uniquely to a UE antenna port. In FIG. 9, the SRS ports of SRS Resource 1 are associated with RX₁ and RX₂. The SRS ports of SRS Resource 2 are associated with RX₃ and RX₄. The SRS ports of SRS Resource 3 are associated with RX₅ and RX₆.

In Opt1.2 of the Second Embodiment, multiple values for n are specified in the spec. and using x-bit(s) in DCI or higher-layer signaling, one value is selected for n, ex: 4 values are defined for n in the spec. Using x=2 bits, one value is selected for n.

In Opt1.3 of the Second Embodiment, it is also possible that the configured n SRS resource sets are from the same resourceType, i.e., ‘aperiodic,’ ‘semi-persistent,’ or ‘periodic.’ In other words, those skilled the art would appreciate that n SRS resource sets should be configured with the same resourceType from the aforementioned list (i.e., one of ‘aperiodic,’ ‘semi-persistent,’ or periodic). Note also that, when resourceType is ‘aperiodic,’ a total of 3 SRS resources are transmitted in different symbols of n SRS resource sets.

One or more advantages of Opt1.3 relate to configuring n resource sets with the same resourceType. In particular, Opt1.3 may provide the flexibility to distribute total K SRS resources among n resource sets. Hence, it is possible to use special slots with 2 UL symbols for SRS antenna switching purposes.

Third Embodiment: DL CSI Acquisition—4T6R Architecture

In Opt.1 of the Third Embodiment, for 4T6R, up to n SRS resource sets each configured with a different value for the higher layer parameter resourceType where each set has 2 SRS resources transmitted in different symbols. Each SRS resource in a given set consists of 4 SRS ports, and each SRS port in a given resource is associated with a unique UE antenna port

In Opt1.1 of the Third Embodiment, n may be specified in the specification. For example, n may be 1, 2, or 3.

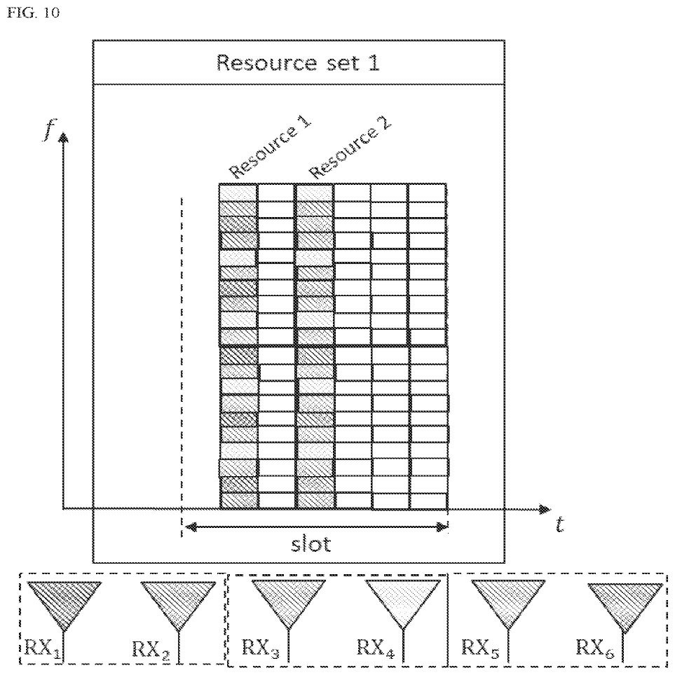

As shown in FIG. 10, for n=1, a single SRS resource set (Resource set 1) having 2 SRS resources (Resources 1 and 2) may be selected. Each SRS port in the SRS resource is associated uniquely with a UE antenna port. Two UE antenna ports may be associated with 2 SRS ports in resource 1 and 2, i.e., repetition.

In Opt1.2 of the Third Embodiment, multiple values for n are specified in the spec. and using x-bit(s) in DCI or higher-layer signaling, one value is selected for n, e.g., 4 values are defined for n in the spec. Using x=2 bits, one value is selected for n.

In Opt1.3 of the Third Embodiment, it is also possible that the configured n SRS resource sets are from the same resourceType, i.e., ‘aperiodic,’ ‘semi-persistent,’ or ‘periodic.’ In other words, those skilled the art would appreciate that n SRS resource sets should be configured with the same resourceType from the aforementioned list (i.e., one of ‘aperiodic,’ ‘semi-persistent,’ or periodic). Note also that, when resourceType is ‘aperiodic,’ a total of 2 or 3 SRS resources are transmitted in different symbols of n SRS resource sets.

Fourth Embodiment: DL CSI Acquisition—4T8R Architecture

In Opt.1 of the Fourth Embodiment, for 4T8R, up to n SRS resource sets each configured with a different value for the higher layer parameter resourceType [3] where each set has 2 SRS resources transmitted in different symbols. Each SRS resource in a given set consisting of 4 SRS ports, and each SRS port of a given resource is associated with a unique UE antenna port

In Opt1.1 of Fourth Embodiment, n is specified in the specification, e.g., n=1, 2, 3.

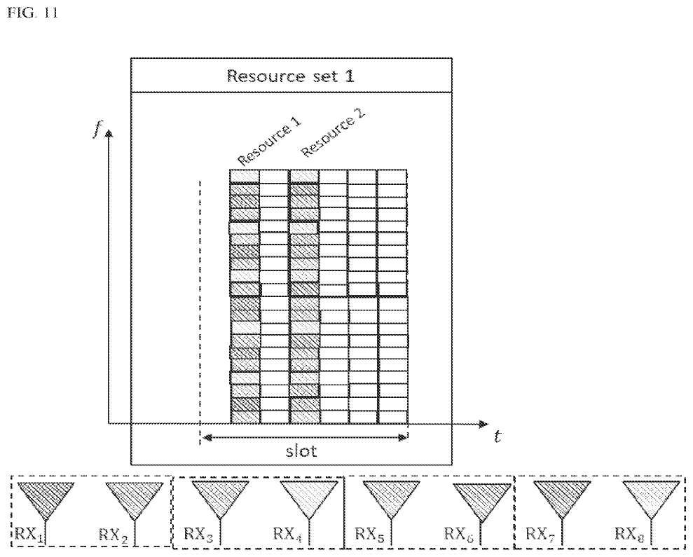

As shown in FIG. 11, for n=1, a single resource set having 2 SRS resources are selected. Each SRS port in a given resource is associated uniquely to a UE antenna port.

In Opt1.2 of Fourth Embodiment, multiple values for n are specified in the specification and using x-bit(s) in DCI or higher-layer signaling, one value is selected for n, e.g., 4 values are defined for n in the spec. Using x=2 bits, one value is selected for n.

In Opt1.3 of the Fourth Embodiment, it is also possible that the configured n SRS resource sets are from the same resourceType, i.e., ‘aperiodic,’ ‘semi-persistent,’ or periodic.' In other words, those skilled the art would appreciate that n SRS resource sets should be configured with the same resourceType from the aforementioned list (i.e., one of aperiodic,' ‘semi-persistent,’ or periodic). Note also that, when resourceType is ‘aperiodic,’ a total of 2 SRS resources are transmitted in different symbols of n SRS resource sets.

For example, for a transceiver architecture of the UE with 4 Tx ports and 8 Rx ports (4T8R), total of 2 SRS resources each having 4 ports are distributed between configured ‘aperiodic’ SRS resource sets.

For example, for a transceiver architecture of the UE with 4 Tx ports and 8 Rx ports (4T8R), 2 SRS resources each having 4 ports are distributed between configured ‘periodic’ SRS resource sets or ‘semi-persistent’ SRS resource sets.

Fifth Embodiment: DL CSI Acquisition—1T6R Architecture

In Opt1 of Fifth Embodiment, for 1T6R, up to n SRS resource sets may each be configured with a different value for the higher layer parameter resource Type, where each set has 6 SRS resources transmitted in different symbols. Further, each SRS resource in a given set may consist of a single SRS port and the SRS port of each resource is associated with a different UE antenna port. It may be considered here that SRS resources can be assigned to any symbol within the slot.

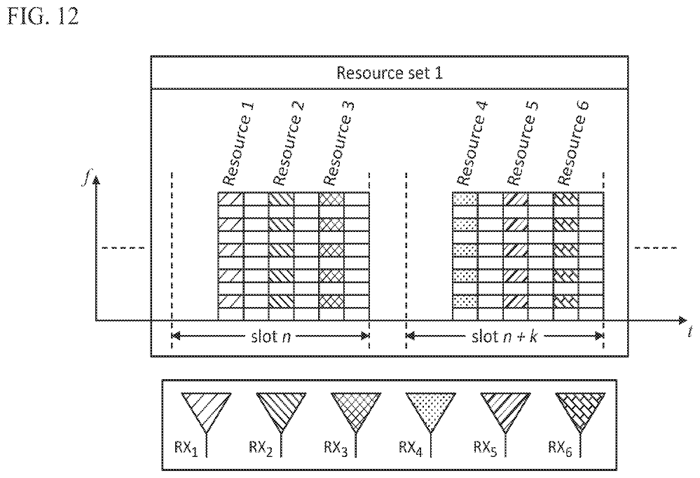

As shown in FIG. 12, 6 SRS resources may be transmitted in different symbols within a slot.

In Opt1.1, n may be specified in the specifications, for example as n=1, 2, 3, . . . etc.

For example, when n=1, a single resource set having 6 SRS resources are selected. A SRS port in a given resource may be associated uniquely to a UE antenna port.

In Opt1.2, multiple values for n may be specified in the specifications and using x-bit(s) in DCI or higher-layer signaling, one value is selected for n. For example, 4 values may be defined for n in the specifications. Using x=2 bits, one value may be selected for n.

In Opt1.3 of the Fifth Embodiment, it is also possible that the configured n SRS resource sets are from the same resourceType, i.e., ‘aperiodic,’ ‘semi-persistent,’ or ‘periodic.’ In other words, those skilled the art would appreciate that n SRS resource sets should be configured with the same resourceType from the aforementioned list (i.e., one of ‘aperiodic,’ ‘semi-persistent,’ or ‘periodic’). Note also that, when resourceType is ‘aperiodic,’ a total of 6 SRS resources are transmitted in different symbols of n SRS resource sets.

Sixth Embodiment: DL CSI Acquisition—1T6R Architecture

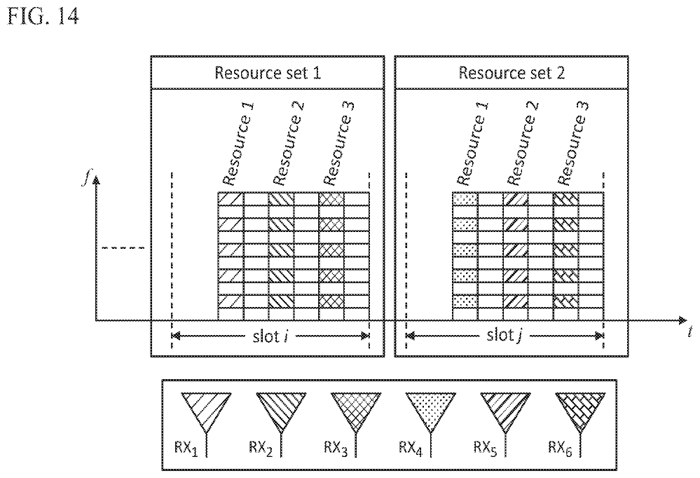

According to Sixth Embodiment, for 1T6R, two SRS resource sets each configured with higher layer parameter resourceType to ‘aperiodic.’ As shown in FIG. 14, each of SRS resource sets 1 and 2 has 3 SRS resources (SRS Resources 1, 2, and 3) transmitted in different symbols. Two SRS resource sets 1 and 2 are transmitted in different slots (slot i and slot j). The SRS port of each of SRS resource is associated with a different UE antenna port. For 1T6R architecture according to Sixth Embodiment, 6 SRS ports are associated with unique UE antenna ports. As shown in FIG. 14, SRS ports in SRS resources 1, 2, and 3 in SRS resource set 1 are associated with RX₁, RX₂, and RX₃, respectively. SRS ports in SRS resources 1, 2, and 3 in SRS resource set 2 are associated with RX₄, RX₅, and RX₆, respectively.

Seventh Embodiment: DL CSI Acquisition—1T6R Architecture

According to Seventh Embodiment, the following higher-layer parameters may be configured with the same value in two aperiodic SRS resource sets captured in Sixth Embodiment: alpha; p0; pathlossReferenceRS; srs-PowerControlAdjustmentStates; aperiodicSRS-ResourceTrigger.

The value of the higher layer parameter slotOffset in each SRS-ResourceSet may be different. Further, it is possible that the same list of t values may be higher layer configured in each SRS-ResourceSet. Then, the same t value is indicated by triggering DCI for both sets.

In addition, it is also possible that the higher layer parameter slot/Offset in each SRS-ResourceSet is the same. Under such situation, it is possible that different lists of t values are higher layer configured in each SRS-ResourceSet. Then, the indicated t value by triggering DCI can be different for both sets.

For a transceiver architecture of the UE with 1 Tx port and 6 Rx ports (1T6R), 6 SRS resources each having 1 port are distributed between configured ‘periodic’ SRS resource sets or ‘semi-persistent’ SRS resource sets.

Eighth Embodiment: DL CSI Acquisition—1T6R Architecture

According to Eighth Embodiment, for 1T6R, three SRS resource sets each with higher layer parameter resourceType configured to ‘aperiodic’ and with total 6 SRS resources transmitted in different symbols of three different slots. The SRS port of each SRS resource is associated with a different UE antenna port.

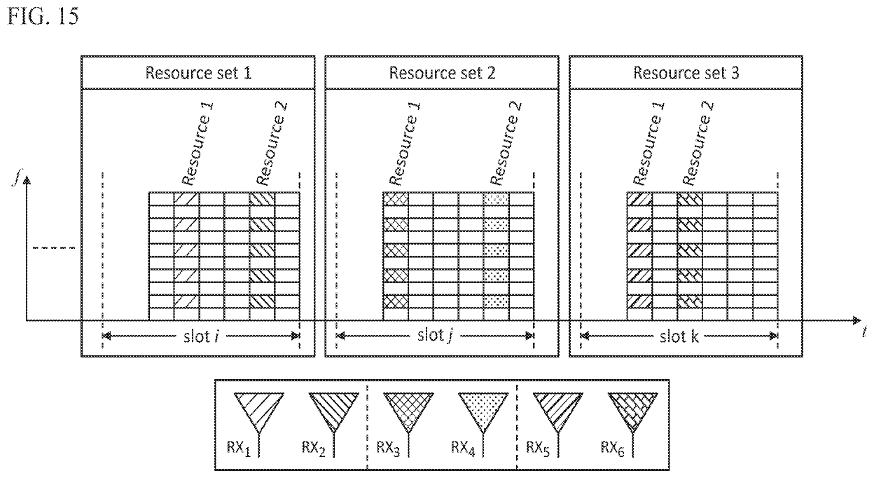

As shown in FIG. 15, each of SRS resource sets 1, 2, and 3 consists of 2 SRS resources (SRS resource 1 and 2). For example, SRS ports in SRS resources 1 and 2 in SRS resource set 1 may be associated with RX₁ and RX₂ UE antenna ports, respectively. SRS ports in SRS resources 1 and 2 in SRS resource set 2 may be associated with RX₃ and RX₄ UE antenna ports, respectively. SRS ports in SRS resources 1 and 2 in SRS resource set 3 may be associated with RX₅ and RX₆ UE antenna ports respectively.

According to Eighth Embodiment, 6 SRS resources can be distributed among SRS resource sets as desired, e.g., (SRS resource set 1, SRS resource set 2, SRS resource set 3)={3, 2, 1}, {2, 3, 1}, {1, 2, 3}, {1, 3, 2}, {2, 1, 3}, {3, 1, 2}. For example, (SRS resource set 1, SRS resource set 2, SRS resource set 3)={3, 2, 1} means that SRS resource sets 1, 2, and 3 include 3 SRS resources, 2 SRS resources, and 1 SRS resource, respectively.

Ninth Embodiment: DL CSI Acquisition—1T6R Architecture

According to Ninth Embodiment, the following higher-layer parameters should be configured with the same value in three aperiodic SRS resource sets captured in Eighth Embodiment: alpha; p0; pathlossReferenceRS; srs-PowerControlAdjustmentStates; aperiodicSRS-ResourceTrigger.

The value of the higher layer parameter slotOffset in each SRS-ResourceSet may be different. Further, it is possible that the same list of t values may be higher layer configured in each SRS-ResourceSet. Then, the same t value is indicated by triggering DCI for all the sets.

In addition, it is also possible that the higher layer parameter slot/Offset in each SRS-ResourceSet is the same. Under such situation, it is possible that different lists of t values are higher layer configured in each SRS-ResourceSet. Then, the indicated t value by triggering DCI can be different for different sets.

For a transceiver architecture of the UE with 1 Tx port and 6 Rx ports (1T6R), total of 6 SRS resources each having 1 port are distributed at most between 3 ‘aperiodic’ SRS resource sets.

Tenth Embodiment: DL CSI Acquisition—1T8R Architecture

According to Tenth Embodiment, for 1T8R, one SRS resource configured with higher layer parameter resourceType in SRS-ResourceSet set to ‘periodic’ or ‘semi-persistent’ with 8 SRS resources transmitted in different symbols, each SRS resource in a given set consisting of a single SRS port, and the SRS port of each SRS resource is associated with a different UE antenna port.

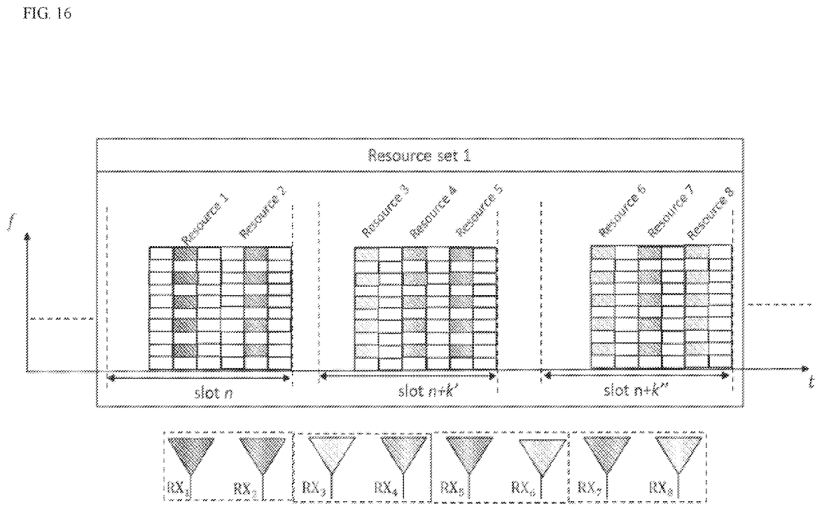

As shown in FIG. 16, 2 SRS resources are transmitted in one slot and other 6 SRS resources are transmitted in two slots each with 3 SRS resources. For example, SRS resources 1 and 2 may be transmitted in slot n, SRS resources 3, 4, and 5 may be transmitted in slot n+k′, and SRS resources 6, 7, and 8 may be transmitted in slot n+k′. SRS ports in SRS resources 1-8 may be associated with RX₁-RX₈, respectively.

Using different T_{offset} value, the starting slot for transmission of a particular SRS resource may be adjusted.

In Opt1.1 of the Tenth Embodiment, it is also possible that n SRS resource sets are configured with resourceType ‘semi-persistent’ or ‘periodic.’ Under such situations, each SRS resource set consists of 8 SRS resources that are transmitted in different symbols.

In Opt1.1.1, a value of n is predefined in the specification(s). For example, n=2 although those skilled in the art will appreciate that other values are not precluded.

In Opt1.1.2, multiple values for n are specified in the specification(s) and, using higher-layer signaling or DCI, one value out of those is selected. For example, n E {1, 2, 3, 4} and then using DCI one value out of these 4 values is selected explicitly or implicitly.

It is noted that T_{SRS} and T_{offset} of different SRS resource sets are configured with different values.

For a transceiver architecture of the UE with 1 Tx port and 8 Rx ports (1T8R), 8 SRS resources each having 1 port are distributed between configured ‘periodic’ SRS resource sets or ‘semi-persistent’ SRS resource sets.

Eleventh Embodiment: DL CSI Acquisition—1T8R Architecture

According to Eleventh Embodiment, for 1T8R, three SRS resource sets each with higher layer parameter resource Type configured to ‘aperiodic’ and with total 8 SRS resources transmitted in different symbols of three different slots. SRS port of each SRS resource is associated with a different UE antenna port.

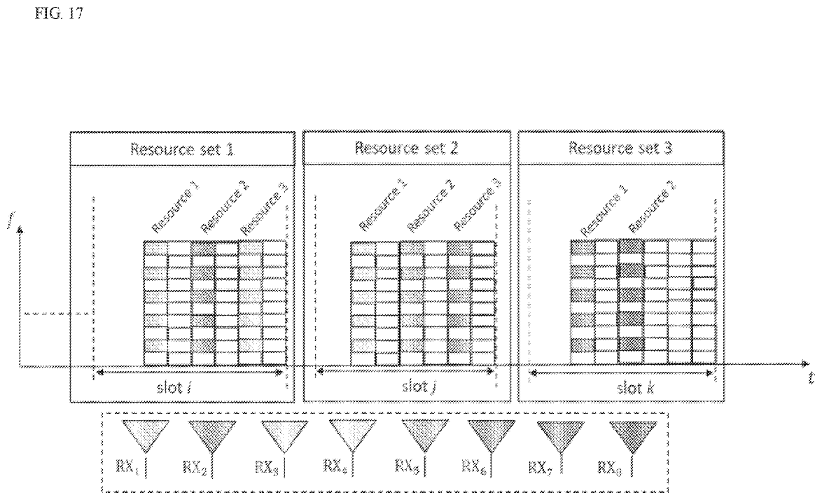

As shown in FIG. 17, 8 SRS resources are distributed as, (SRS resource set 1, SRS resource set 2, SRS resource set 3)={3, 3, 2}. In terms of delay, it may be beneficial to have 3 SRS resources each in first two resource sets.

In Eleventh Embodiment, 8 SRS resources may be distributed among SRS resource sets as desired, e.g., (SRS resource set 1, SRS resource set 2, SRS resource set 3)={3, 2, 3}, {2, 3, 3}.

For a transceiver architecture of the UE with 1 Tx port and 8 Rx ports (1T8R), total of 8 SRS resources each having 1 port are distributed at most between 4 ‘aperiodic’ SRS resource sets.

Twelfth Embodiment: DL CSI Acquisition—1T8R Architecture

According to Twelfth Embodiment, the following higher-layer parameters should be configured with the same value in three aperiodic SRS resource sets captured in Eleventh Embodiment: alpha; p0; pathlossReferenceRS; srs-PowerControlAdjustmentStates; aperiodicSRS-ResourceTrigger. The value of the higher layer parameter slotOffset in each SRS-ResourceSet may be different.

The value of the higher layer parameter slotOffset in each SRS-ResourceSet may be different. Further, it is possible that the same list of t values may be higher layer configured in each SRS-ResourceSet. Then, the same t value is indicated by triggering DCI for all the sets.

In addition, it is also possible that the higher layer parameter slot/Offset in each SRS-ResourceSet is the same. Under such situation, it is possible that different lists of t values are higher layer configured in each SRS-ResourceSet. Then, the indicated t value by triggering DCI can be different for different sets.

DL CSI Acquisition with 1T8R Architecture

As it can be observed from Tenth and Eleventh Embodiments, it requires 3 slots to acquire DL CSI from SRS with resourceType ‘periodic’, ‘semi-persistent’ and ‘aperiodic’. This is due to following reasons:

Each SRS resource has one port−>since 1T8R architecture has 1 Tx-port; and

There needs to be at least 1 symbol gap between two SRS resources.

Due to above limitations, max. possible number of SRS resources per slot is 3 and there are 8 resources in total that need to be transmitted−>Hence, 3 slots.

Thirteenth Embodiment: DL CSI Acquisition—2T8R Architecture

According to Opt1 of Thirteenth Embodiment, for 2T8R, one SRS resource set configured with higher layer parameter resourceType to ‘periodic’ or ‘semi-persistent’ with 4 SRS resources transmitted in different symbols, each SRS resource in a given set consisting of two SRS ports, and the SRS port pair of each SRS resource is associated with a different UE antenna port pair.

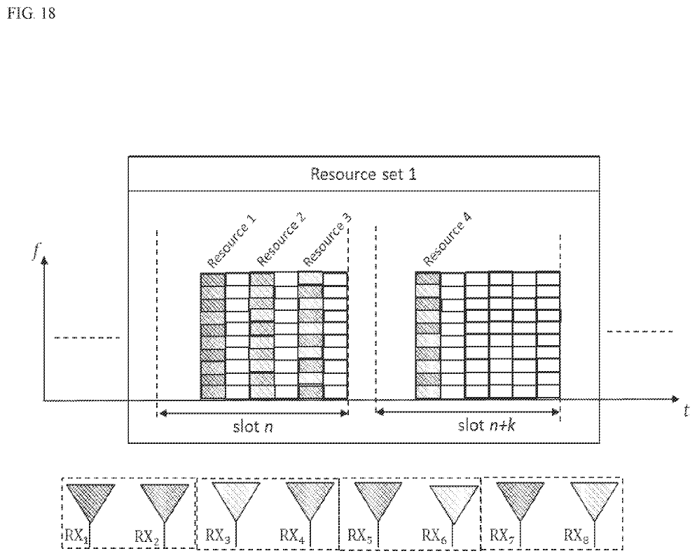

As shown in FIG. 18, 3 SRS resources (SRS resources 1, 2, and 3) are transmitted in one slot (slot n) and the other SRS resource (SRS resource 4) is transmitted in a different slot (slot n+k). For example, SRS ports in SRS resource 1 may be associated with RX₁ and RX₂. SRS ports in SRS resource 2 may be associated with RX₃ and RX₄. SRS ports in SRS resource 3 may be associated with RX₅ and RX₆. SRS ports in SRS resource 4 may be associated with RX₇ and RX₈.

Using different T_{offset} value, starting slot for transmission of a particular SRS resource can be controlled.

In Opt1.1, it is also possible that n SRS resource sets are configured with resourceType ‘semi persistent’ or ‘periodic.’ Under such situations, each SRS resource set consists of 4 SRS resources that are transmitted in different symbols.

In Opt1.1.1, a value of n is predefined in the specification(s). For example, n=2 although those skilled in the art will appreciate that other values are not precluded.

In Opt1.1.2, multiple values for n are specified in the specification(s) and, using higher-layer signaling or DCI, one value is selected. For example, n E {1, 2, 3, 4} and then using DCI one value out of these 4 values is selected explicitly or implicitly.

It is noted that, T_{SRS} and T_{offset} of different SRS resource sets are configured with different values.

For a transceiver architecture of the UE with 2 Tx ports and 8 Rx ports (2T8R), 4 SRS resources each having 2 ports are distributed between configured ‘periodic’ SRS resource sets or ‘semi-persistent’ SRS resource sets.

Fourteenth Embodiment: DL CSI Acquisition—2T8R Architecture

According to Fourteenth Embodiment, for 2T8R, two SRS resource sets each with higher layer parameter resourceType configured to ‘aperiodic’ and with total 4 SRS resources transmitted in different symbols of two different slots. Each SRS resource in a given set consisting of two SRS ports and two SRS ports of each SRS resource is associated with a different UE antenna port pair.

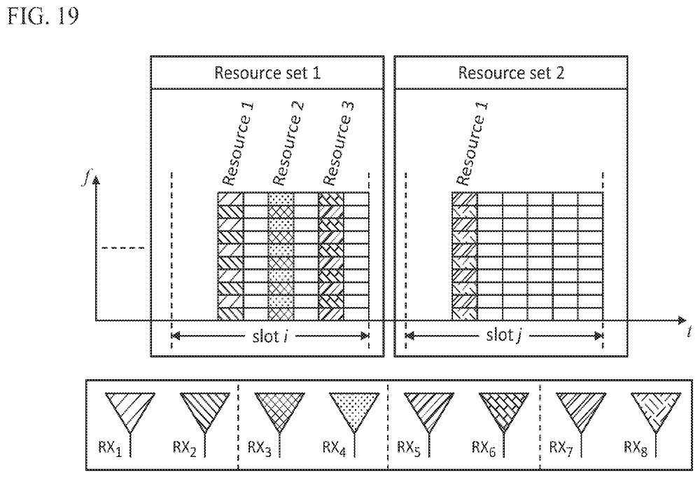

As shown in FIG. 19, 4 SRS resources may be distributed as, (SRS resource set 1, SRS resource set 2)={3, 1}. In terms of delay, it may beneficial to have 3 SRS resources in first resource set. For example, in SRS resource set 1, SRS ports in SRS resource 1 may be associated with RX₁ and RX₂, SRS ports in SRS resource 2 may be associated with RX₃ and RX₄, SRS ports in SRS resource 3 may be associated with RX₅ and RX₆. In SRS resource set 2, SRS ports in SRS resource 1 may be associated with RX₇ and RX₈.

In Fourteenth Embodiment, 4 SRS resources may be distributed among SRS resource sets as desired, e.g., (SRS resource set 1, SRS resource set 2)={2, 2}, {1, 3}.

Further, in terms of delay, it may be beneficial to have 3 SRS resources in the first resource set.

For a transceiver architecture of the UE with 2 Tx ports and 8 Rx ports (2T8R), total of 4 SRS resources each having 2 ports are distributed at most between 4 ‘aperiodic’ SRS resource sets.

Fifteenth Embodiment: DL CSI Acquisition—2T8R Architecture

According to Fifteenth Embodiment, the following higher-layer parameters should be configured with the same value in two aperiodic SRS resource sets captured in Fourteenth Embodiment: alpha; p0; pathlossReferenceRS; srs-PowerControlAdjustmentStates; aperiodicSRS-ResourceTrigger.

The value of the higher layer parameter slotOffset in each SRS-ResourceSet may be different. Further, it is possible that the same list of t values may be higher layer configured in each SRS-ResourceSet. Then, the same t value is indicated by triggering DCI for all the sets. In addition, it is also possible that the higher layer parameter slot/Offset in each SRS-ResourceSet is the same. Under such situation, it is possible that different lists of t values are higher layer configured in each SRS-ResourceSet. Then, the indicated t value by triggering DCI can be different for different sets.

For a transceiver architecture of the UE with 1 Tx port and 8 Rx ports (1T8R), total of 8 SRS resources each having 1 port are distributed at most between 4 ‘aperiodic’ SRS resource sets.

Sixteenth Embodiment: DL CSI Acquisition—2T8R Architecture

In Opt1 of the Sixteenth Embodiment, for 2T8R, up to n SRS resource sets each configured with a different value for the higher layer parameter resource Type, where each set has 4 SRS resources transmitted in different symbols. Each SRS resource in a given set may consist of two SRS ports, and the SRS port pair of each resource may be associated with a different UE antenna port pair. Further, SRS resources can be assigned to any symbol within the slot.

In Opt1.1 of the Sixteenth Embodiment, n is specified in the specification, For example, n=1, 2, 3.

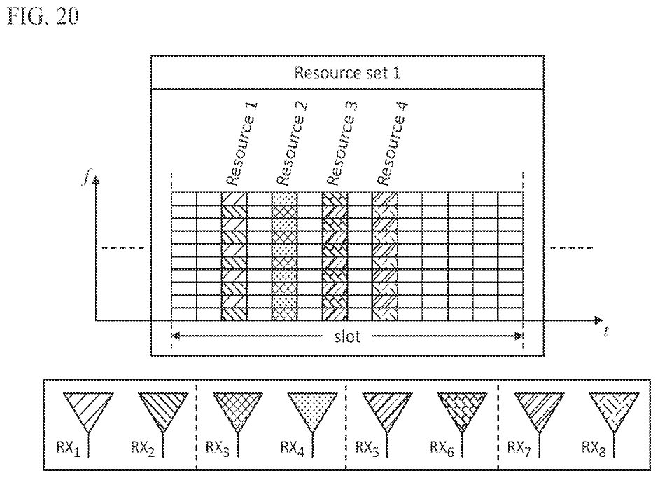

As shown in FIG. 20, for n=1, single resource set having 4 SRS resources are selected. Each SRS resource is associated uniquely to a UE antenna port.

In Opt1.2 of the Sixteenth Embodiment, multiple values for n are specified in the specifications and using x-bit(s) in DCI or higher-layer signaling, one value is selected for n. For example, 4 values are defined for n in the spec. Using x=2 bits, one value is selected for n.

In Opt1.3 of the Sixteenth Embodiment, it is also possible that the configured n SRS resource sets are from the same resourceType, i.e., ‘aperiodic,’ ‘semi-persistent,’ or periodic.' In other words, those skilled the art would appreciate that n SRS resource sets should be configured with the same resourceType from the aforementioned list (i.e., one of aperiodic,' ‘semi-persistent,’ or periodic). Note also that, when resourceType is aperiodic,' a total of 4 SRS resources are transmitted in different symbols of n SRS resource sets.

Seventeenth Embodiment: DL CSI Acquisition—1T6R Architecture

In Opt1 of Seventeenth Embodiment, for 1T6R, one SRS resource set may be configured with higher layer parameter resourceType set to ‘periodic’ or ‘semi-persistent’ with 6 SRS resources transmitted in different symbols, each SRS resource in a given set consisting of a single SRS port, and the SRS port of each resource is associated with a different UE antenna port.

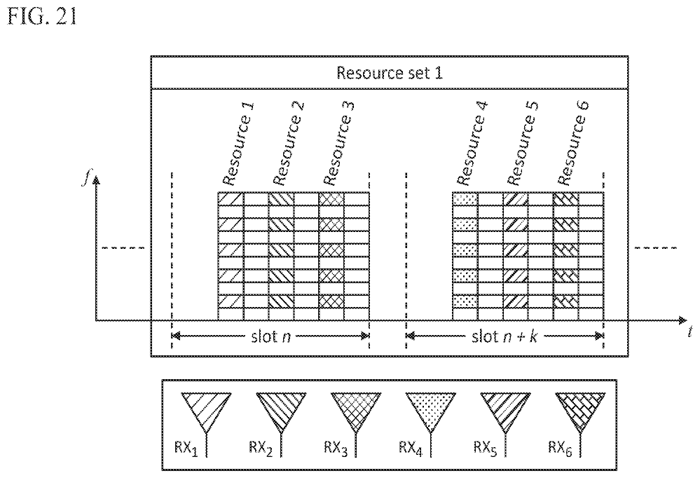

As shown in FIG. 21, 6 SRS resources may be transmitted in different symbols within a slot. For example, 3 SRS resources are transmitted in one slot while the other 3 resources are in a different slot.

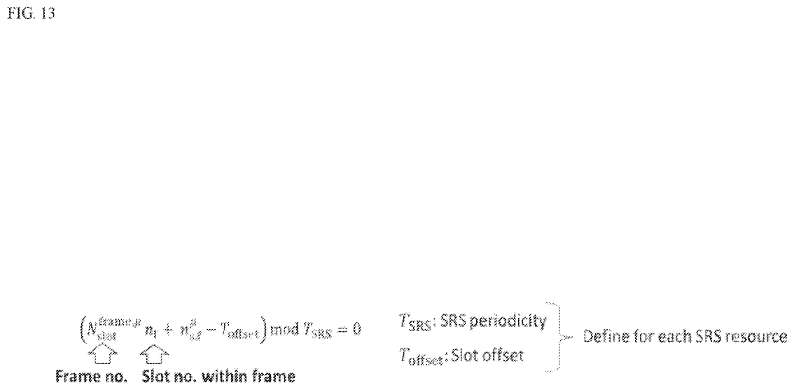

To determine slots transmitting a particular SRS resource, an equation indicated in FIG. 13 may be applied. In this equation, TSRS of all SRS resources in the same set are the same. However, using different T_{offset} value, starting slot for transmission of a particular SRS resource can be controlled.

In Opt1.1 of the Seventeenth Embodiment, it is also possible that n SRS resource sets are configured with resourceType as ‘semi-persistent’ or ‘periodic.’ Under such situations, each SRS resource set consists of 6 SRS resources, which are transmitted in different symbols.

In Opt1.1.1, a value of n may be predefined in the specification(s). For example, n=2, but those skilled in the art will appreciate that other values are not precluded.

In Opt1.1.2, multiple values for n are specified in the specification(s) and, using higher-layer signaling or DCI, one value is selected. For example, n E {1, 2, 3, 4} and then using DCI, one value out of these 4 values is selected explicitly or implicitly.

It is noted that T_{SRS} and T_{offset} of different SRS resource sets are configured with different values.

One or more advantages provided by the Seventeenth Embodiment may relate to configuring n resource sets with the same resourceType. That is, one or more advantages may provide the opportunity to activate one of the sets in order to avoid collisions. It is also noted that different SRS resource sets are configured with different periodicities.

Eighteenth Embodiment: When Two Slots Are Required for DL CSI Acquisition

If SRS resources for DL CSI acquisition are transmitted in two different slots, potential options include the following.

Opt1 of the Eighteenth Embodiment: if slot offset is not configured for an SRS resource, then that SRS resource will be transmitted in the second slot when resourceType is ‘periodic’ or ‘semi-persistent.’

Opt2 of the Eighteenth Embodiment: flexible assigning of antenna ports for DL CSI acquisition within the first and second slots may occur according to one or more of the following options: Opt2.1: can be higher layer configured, for example if there are 6 ports, a UE can be configured to sound ports 1, 3, and 5 in the 1^{st} slot and ports 2, 4, and 6 in the 2^{nd} slot; or Opt2.2: can be configured using x-bit(s) in DCI, for example if there are 6 ports, a UE can be configured to sound ports 1, 3, and 5 in the 1^{st} slot using a bitmap 101010. Whatever the ports not sounded in the 1^{st} slot will be sounded in the next slot. Further, each antenna port is uniquely associated to an SRS port of a particular SRS resource.

Opt3 of the Eighteenth Embodiment: Two resource sets of different resourceType can be configured for 1^{st} and 2^{nd} slots, e.g. 1^{st} slot−>‘periodic’ ‘semi-persistent’ and 2^{nd} slot−>‘A-periodic.’

For a transceiver architecture of the UE with 1 Tx port and 6 Rx ports (1T6R), total of 6 SRS resources each having 1 port are distributed at most between 3 ‘aperiodic’ SRS resource sets.

Nineteenth Embodiment: When Three Slots Are Required for DL CSI Acquisition

If SRS resources for DL CSI acquisition are transmitted in three different slots, potential options include the following.

Opt1 of the Nineteenth Embodiment: flexible assigning of antenna ports for DL CSI acquisition within the first, second and third slots.

Opt1.1 of the Nineteenth Embodiment: Flexible assigning can be higher layer configured, for example if there are 8 ports, a UE can be configured to sound ports 1, 2, and 3 in the 1^{st} slot, 4, 5, and 6 in the 2^{nd} slot and 7, and 8 in the 3^{rd} slot.

Opt1.2 of the Nineteenth Embodiment: Flexible assigning can be configured using x-bit(s) in DCI, for example if there are 8 ports, a UE can be configured to sound ports 1, 2, and 3 in the 1^{st} slot using a bitmap 11100000 and 4, 5, and 6 in the 2^{nd} slot using a bitmap 00011100. Whatever the ports not sounded in 1^{st} and 2^{nd} slots will be sounded in the 3^{rd} slot.

Further, each antenna port may be uniquely associated to an SRS port of a particular SRS resource.

Twentieth Embodiment: DL CSI Acquisition—1T8R Architecture

In Opt1 of Twentieth Embodiment, for 1T8R, one SRS resource configured with higher layer parameter resourceType in SRS-ResourceSet set to ‘periodic’ or ‘semi-persistent’ with 8 SRS resources transmitted in different symbols, each SRS resource in a given set consisting of a single SRS port, and the SRS port of each resource is associated with a different UE antenna port. Further, SRS resources can be assigned to any symbol within the slot.

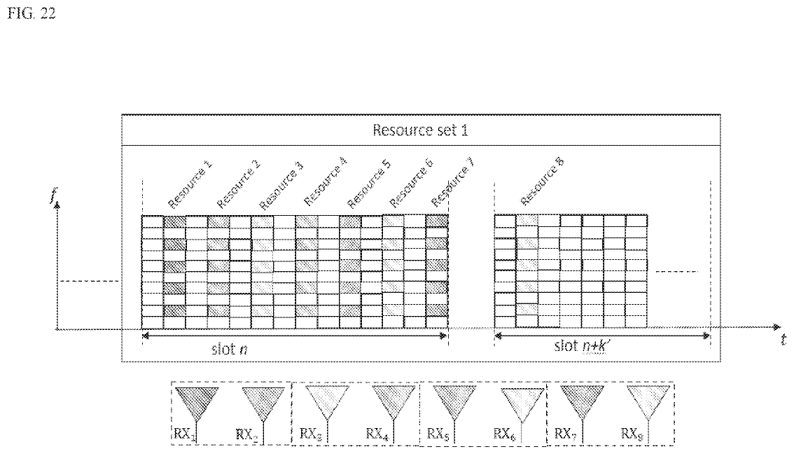

As shown in FIG. 22, for example, 7 SRS resources are transmitted in one slot while the other SRS resource is transmitted in the second slot.

To determine slots transmitting a particular SRS resource, an equation indicated in FIG. 13 may be applied. In this equation, TSRS of all SRS resources in the same set are the same. However, using different T_{offset} value, starting slot for transmission of a particular SRS resource can be controlled.

For a transceiver architecture of the UE with 1 Tx port and 8 Rx ports (1T8R), 8 SRS resources each having 1 port are distributed between configured ‘periodic’ SRS resource sets or ‘semi-persistent’ SRS resource sets.

Twenty-First Embodiment: DL CSI Acquisition—1T8R Architecture

In Opt1 of Twenty-First Embodiment, for 1T8R, two SRS resource sets each with higher layer parameter resourceType configured to ‘aperiodic’ and with total 8 SRS resources (each having a single port) transmitted in different symbols of two sets. SRS port of each SRS resource is associated with a different UE antenna port. For a transceiver architecture of the UE with 1 Tx port and 8 Rx ports (1T8R), total of 8 SRS resources each having 1 port are distributed at most between 4 ‘aperiodic’ SRS resource sets.

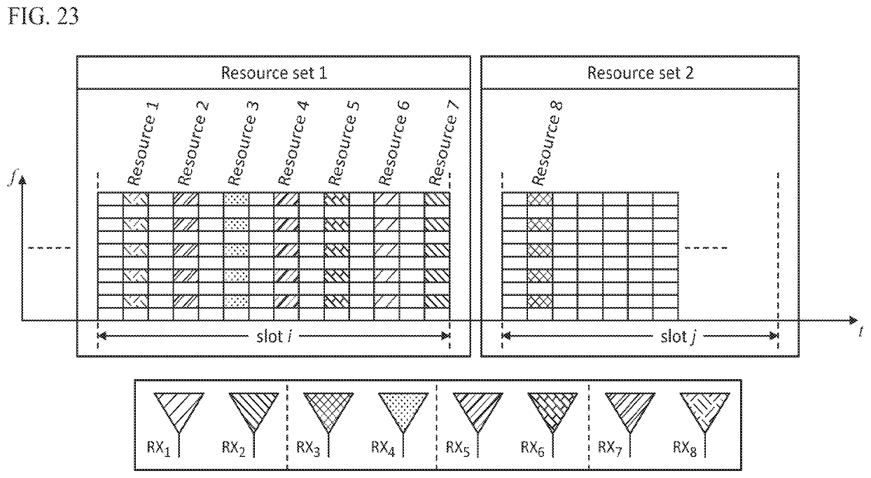

As shown in FIG. 23, for example, 8 SRS resources are distributed as, (set 1, set 2)={7, 1}.

In Opt1.1 of the Twenty-First Embodiment, 8 SRS resources can be distributed among SRS resource sets freely, Ex: (set 1, Set 2)={4, 4}, {5, 3}, {6, 2}, {1, 7}, {2, 6}, {3, 5}.

Twenty-Second Embodiment: When Two Slots Are Required for DL CSI Acquisition

If SRS resources for DL CSI acquisition are transmitted in two different slots, potential options include the following.

Opt1 of the Twenty-Second Embodiment: if slot offset is not configured for an SRS resource in the SRS resource set, then that SRS resource will be transmitted in the second slot when resourceType is ‘periodic’ or ‘semi-persistent’.

Opt2 of the Twenty-Second Embodiment: which antenna ports to be sounded in the first and second slots can be configured according to one or more of the following options.

Opt2.1: can be higher layer configured, for example if there are 8 ports, a UE can be configured to sound ports 1, 3, 5, and 7 in the 1^{st} slot and ports 2, 4, 6, and 8 in the second slot.

Opt2.2: can be configured using x-bit(s) in DCI, for example if there are 6 ports, a UE can be configured to sound ports 1, 3, 5, and 7 in the 1^{st} slot using a bitmap 10101010. Whatever ports not sounded in first slot will be sounded in the next slot.

Further, each antenna port is uniquely associated to an SRS port of a particular SRS resource.

Opt3 of the Twenty-Second Embodiment: two different resource sets of different resourceType can be configured for first and second slots, e.g. 1^{st} slot−>‘periodic’ ‘semi-persistent’ and 2^{nd} slot−>‘A-periodic’ for DL CSI acquisition.

Twenty-Third Embodiment: DL CSI Acquisition—No Symbol Gap Between SRS Resources

In Opt1 of the Twenty-Third Embodiment, no symbol gap is required between consecutive SRS resources in an SRS resource set configured with usage as ‘antenna switching.’

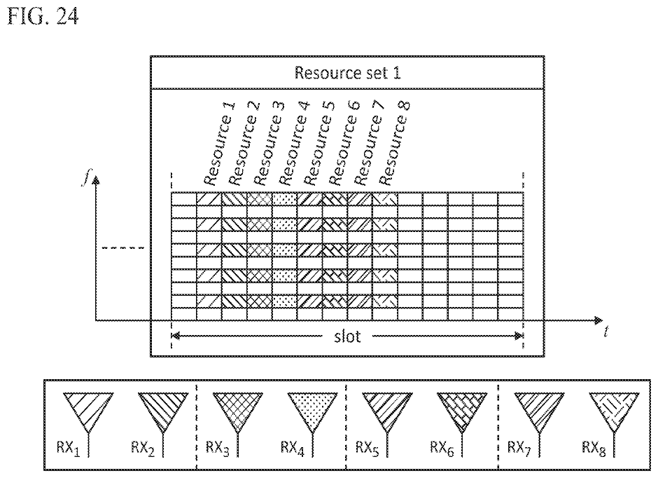

For example, as shown in FIG. 24, for 1T8R, 8 SRS resources in an SRS resource set may be configured within a single slot with no symbol gap between two consecutive resources.

In Opt1.1 of the Twenty-Third Embodiment, a UE reports as part of its capability reporting whether it can support no-symbol gap SRS transmission for SRS resource set(s) configured with usage as ‘antenna switching’. Only such UEs can be configured with SRS resource sets having SRS resources with no-symbol gap for DL CSI acquisition.

Additionally, UEs that do not report as part of their capability reporting that it can support no-symbol gap SRS transmission for SRS resource set(s) configured with usage as ‘antenna switching’ are not configured with SRS resource sets having SRS resources with no-symbol gap for DL CSI acquisition.

Twenty-Fourth Embodiment: DL CSI Acquisition—1T6R Architecture

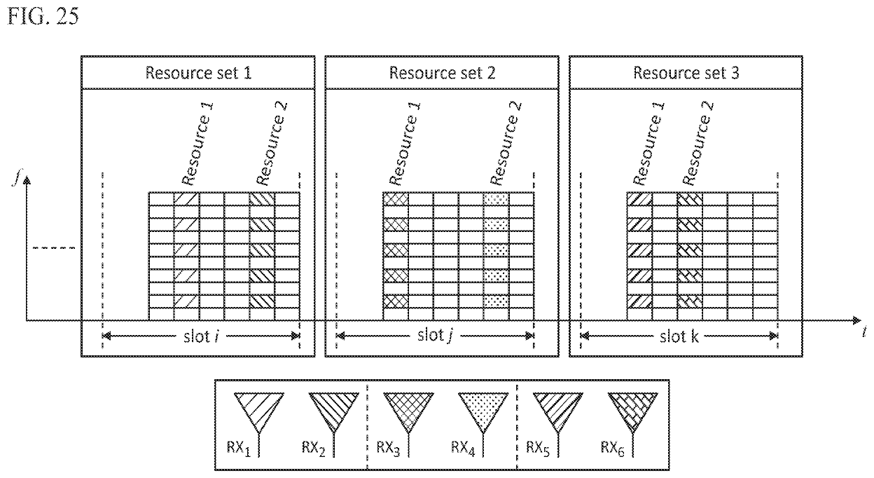

In Opt1 of the Twenty-Fourth Embodiment, for 1T6R three SRS resource sets each with higher layer parameter resourceType configured to ‘aperiodic’ [3] and with total 6 SRS resources (each having a single port) are transmitted in different symbols of three sets. A SRS port of each SRS resource is associated with a different UE antenna port. For example, as shown in FIG. 25, each resource set consists of 2 SRS resources.

In Opt. 1.1, 6 SRS resources can be distributed among SRS resource sets freely. For example, (set 1, set 2, set 3)={3, 2, 1}, {2, 3, 1}, {1, 2, 3},{1, 3, 2}, {2, 1, 3}, {3, 1, 2}.

In Opt. 1.2, it is also possible that 6 SRS resources are distributed among 1, 2 or 4 SRS resource sets freely,

In Opt. 1.2.1, there can be multiple values for number of SRS resource sets defined in the specification(s) and, using higher-layer signaling or DCI, one value out can be selected. Then, 6 resources are distributed among those selected number of sets.

For a transceiver architecture of the UE with 1 Tx port and 6 Rx ports (1T6R), total of 6 SRS resources each having 1 port are distributed at most between 3 ‘aperiodic’ SRS resource sets.

Twenty-Fifth Embodiment: DL CSI Acquisition—1T8R Architecture

In Opt1 of the Twenty-Fifth Embodiment, for 1T8R three SRS resource sets each with the higher layer parameter resourceType are configured to ‘aperiodic’ [3] and with total 8 SRS resources (each having a single port) are transmitted in different symbols of three sets. A SRS port of each SRS resource is associated with a different UE antenna port.

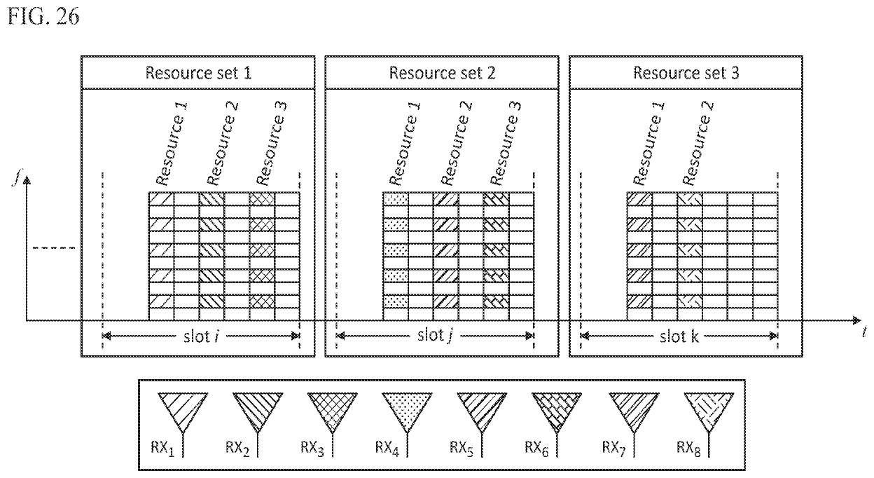

For example, as shown in FIG. 26, 8 SRS resources are distributed as (set 1, set 2, set 3)={3, 3, 2}. In terms of delay, it may be beneficial to have 3 SRS resources each in first two resource sets.

In Opt. 1.1, 8 SRS resources can be distributed among SRS resource sets freely. For example, (set 1, set 2, set 3)={3, 2, 3}, {2, 3, 3}.

In Opt. 1.2, it is also possible that 8 SRS resources are distributed among 4 SRS resource sets freely.

Twenty-Sixth Embodiment: DL CSI Acquisition—2T8R Architecture

In Opt1, for 2T8R two SRS resource sets each with higher layer parameter resourceType are configured to ‘aperiodic’ and with a total of 4 SRS resources are transmitted in different symbols of two sets. Each SRS resource in a given set consisting of two SRS ports and two SRS ports of each SRS resource is associated with a different UE antenna port pair

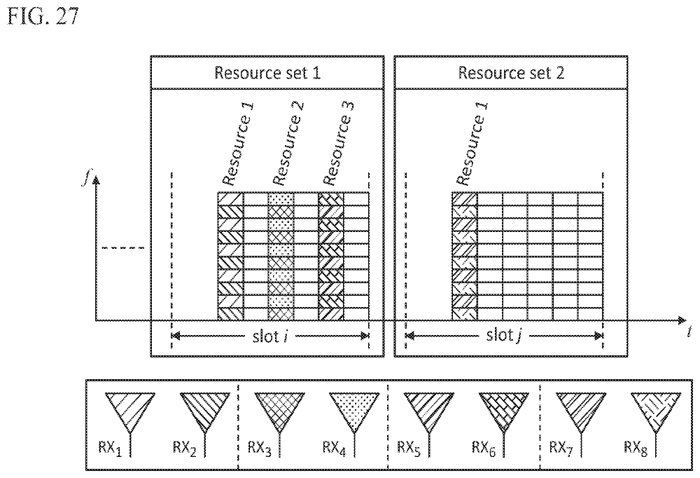

For example, as shown in FIG. 27, 4 SRS resources are distributed as, (set 1, set 2) ={3, 1}. In terms of delay, it may be beneficial to have 3 SRS resources each in first resource set.

In Opt. 1.1, 4 SRS resources can be distributed among SRS resource sets freely. For example, (set 1, Set 2)={2, 2}, {1, 3}.

In Opt. 1.2, it is also possible that 4 SRS resources are distributed among 1, 3 or 4 SRS resource sets freely.

In Opt. 1.2.1, there can be multiple values for a number of SRS resource sets defined in the specification(s) and, using higher-layer signaling or DCI, one value can be selected. Then, 6 resources are distributed among those selected number of sets.

For a transceiver architecture of the UE with 2 Tx ports and 8 Rx ports (2T8R), total of 4 SRS resources each having 2 ports are distributed at most between 4 ‘aperiodic’ SRS resource sets.

Configuration of BS

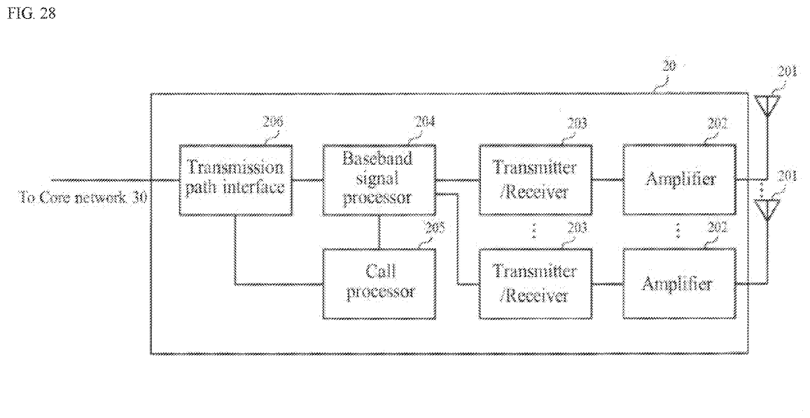

The BS 20 according to embodiments of the present invention will be described below with reference to FIG. 28. FIG. 28 is a diagram illustrating a schematic configuration of the BS 20 according to embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 10 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antenna 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network through the transmission path interface 206. The call processor 205 performs call processing such as setting up and releasing a communication channel, manages the state of the BS 20, and manages the radio resources.

Configuration of UE

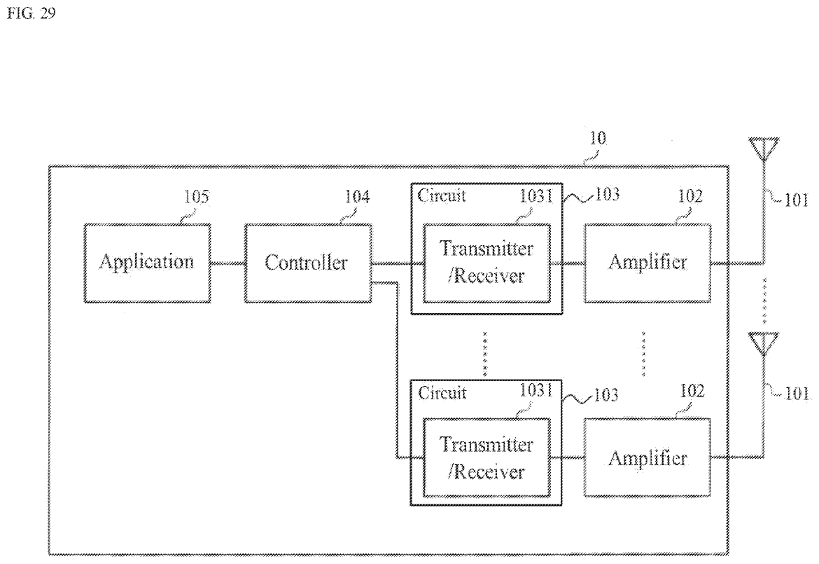

The UE 10 according to embodiments of the present invention will be described below with reference to FIG. 29. FIG. 29 is a schematic configuration of the UE 10 according to embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

Another Example

The above examples and modified examples may be combined with each other, and various features of these examples may be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A user equipment (UE) comprising:
Rx antenna ports wherein a number of the Rx antenna ports is less than or equal to 8;
a transmitter that transmits a sounding reference signal (SRS) using the antenna ports; and
a processor that switches the Rx antenna ports for the SRS transmission.

2. The UE according to claim 1, wherein the number of Rx antenna ports is 8.

3. A method of communicating with a user equipment (UE) comprising 8 Rx antenna ports, the method comprising:
transmitting, to a base station, a sounding reference signal (SRS); and
switching among the 8 Rx antenna ports for the SRS transmission.

4. The UE according to claim 1, wherein
a UE capability indication parameter includes supportedSRS-TxPortSwitch that is associated with usage ‘antennaswitching,’ and
the ‘antennaswitching’ is updated to capture new transceiver architectures.

5. The UE according to claim 1, wherein for a transceiver architecture of the UE with 1 Tx port and 6 Rx ports (1T6R), total of 6 SRS resources each having 1 port are distributed at most between 3 ‘aperiodic’ SRS resource sets.

6. The UE according to claim 1, wherein for a transceiver architecture of the UE with 1 Tx port and 8 Rx ports (1T8R), total of 8 SRS resources each having 1 port are distributed at most between 4 ‘aperiodic’ SRS resource sets.

7. The UE according to claim 1, wherein for a transceiver architecture of the UE with 2 Tx ports and 8 Rx ports (2T8R), total of 4 SRS resources each having 2 ports are distributed at most between 4 ‘aperiodic’ SRS resource sets.

8. The UE according to claim 1, wherein for a transceiver architecture of the UE with 4 Tx ports and 8 Rx ports (4T8R), total of 2 SRS resources each having 4 ports are distributed between configured ‘aperiodic’ SRS resource sets.

9. The UE according to claim 1, wherein each ‘aperiodic’ SRS resource set configured with usage ‘antennaswitching’ for a particular transceiver architecture has different values for higher-layer parameters slotOffset and/or t-values list.

10. The UE according to claim 1, wherein for a transceiver architecture of the UE with 1 Tx port and 6 Rx ports (1T6R), 6 SRS resources each having 1 port are distributed between configured one or more ‘periodic’ SRS resource set(s) or one or more ‘semi-persistent’ SRS resource set(s).

11. The UE according to claim 1, wherein for a transceiver architecture of the UE with 1 Tx port and 8 Rx ports (1T8R), 8 SRS resources each having 1 port are distributed between configured one or more ‘periodic’ SRS resource set(s) or one or more ‘semi-persistent’ SRS resource set(s).

12. The UE according to claim 1, wherein for a transceiver architecture of the UE with 2 Tx ports and 8 Rx ports (2T8R), 4 SRS resources each having 2 ports are distributed between configured one or more ‘periodic’ SRS resource set(s) or one or more ‘semi-persistent’ SRS resource set(s).

13. The UE according to claim 1, wherein for a transceiver architecture of the UE with 4 Tx ports and 8 Rx ports (4T8R), 2 SRS resources each having 4 ports are distributed between configured one or more ‘periodic’ SRS resource set(s) or one or more ‘semi-persistent’ SRS resource set(s).

14. The UE according to claim 1, wherein SRS resource sets with usage ‘antennaswitching’ have zero-symbol gap SRS resources.

15. The UE according to claim 1, Zero-symbol gap SRS resource configuration is based on UE capability.
